(19) United States
(12) Patent Application Publication
(10) Pub. No.: US 2008/0034278 A1
(43) Pub. Date: Feb. 7, 2008

(54) Integrated interactive multimedia playing system

(76) Inventors: Ming-Chih Tsou, Chu-Ton Town (TW); Ke-Ming Lee, Hsin-Chu City (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/491,185

(22) Filed: Jul. 24, 2006

(51) Int. Cl. G06F 17/00; G06F 3/00; G06F 15/16

(52) U.S. Cl. 715/203; 715/201; 715/202; 715/730; 709/231

(57) ABSTRACT

An interactive multimedia integration system includes an input unit, a file format recognition unit, an editing unit, a format generating unit. The editing unit is for integrating selected interaction data into a combined multimedia file. The format generating unit produces an integrated interactive multimedia file upon a request from the user. The integrated interactive multimedia file contains at least three formats which are a raw interactive multimedia file, a dedicated interactive multimedia file and an ordinary file attached an interactive script which contains the interaction data selected by the user. The integrated interactive multimedia file is playable in an ordinary playing device without interactive functions, or a dedicated playing device with specific interactive functions. When a pre-determined function key is pressed by the user, a specific interactive effect recorded in the interaction data is therefore initiated and performed with the help of decryption conducted by an interaction decrypting module.

### BACKGROUND OF THE INVENTION

1. Field of the Invention

The present invention relates to an integrated interactive multimedia playing system for displaying integrated interactive multimedia files with special interactive effects, and more particularly relates to an interactive playing system to play interactive multimedia file when a function key is pressed and thereto initiates a specific interactive effect defined by the function key.

2. The Related Art

Since the present hardware and software in computing technologies are developing more and more advanced continuously, the capability of handling mass dada analysis and media contents are increased dramatically as well. Further by the support of the decoding software, most of the multimedia files with different formats are therefore capable to be played via a personal computer. The user simply clicks on the file shown in the file browsers and the display of the personal computer is able to play footages as chosen. There is no need of utilizing an auxiliary multimedia complier or transforming software to transfer the multimedia file from one file format to another file format. However, since the hardware and the firmware of portable devices, such as the digital still camera, digital camcorder, mobile phone, personal digital assistant, personal media player and the gaming device, are dramatically improved, the functions and capabilities of the portable devices are enhanced as well. The additional functions, beside the primary working functions, are usually the gaming, photo taking, movie recording, diary detailing and others, which are available to the market. Now the camera for taking still photos and video clips, and the large display for playing the recorded clips are the most popular auxiliary function to most of the portable devices. In order to acquire the good quality of clips, different manufacturers employ different compression format, such as MOV, MPEG-4, AVI and so on. Besides, the multimedia files are usually consuming large memory for images and sounds. This result also makes the memory card getting larger and larger capacity such as 512 MB, 1 GB, 2 GB or even 4 GB.

Some other manufacturers may develop the dedicated multimedia file format to achieve individual requirements. The dedicated file format may benefit on sound quality and small size of file, but giving away the video quality. The other dedicated file format may benefit on video clips, but giving away both the file size and the sound quality. However, no matter what dedicated file format is chosen or developed, the basic problem is that such file is unplayable on the other device that does not support such dedicated file format. Sometimes, if the personal computer does not install the dedicated driver for such portable device, the dedicated multimedia file is unable to be transferred to the storage of the computer.

Even though the portable devices are limited somehow by the hardware and firmware, such as unable to modify or share files to other portable devices, the format transforming or modifying function can be done by the assistant of the computer if installed the needed driver and the software. However, the interactive actions are not introduced to the multimedia file. The portable device is only capable to simply play, pause, or stop the transformed or the modified multimedia file.

Besides, some manufacturers have chosen a commonly utilized file format into their devices for popularly sharing purpose, such as choosing MOV, AVI or MPEG-4. But the drawbacks are that these kinds of formats are still not supporting the interactive action or function to the multimedia file itself. The commonly utilized file format is simply read to play the multimedia contents to the viewer on an embedded display by the portable device. Even if the manufacturer develops a dedicated file format capable of showing interactive functions, it is unable to be shared by the other devices since the file format is unique and dedicated to its brand. Therefore, there is a need to develop a universal file format or a multimedia file which is capable to generate interactive functions as well as sharing interactive multimedia files to each other in different brands or different manufacturers.

Furthermore, upon another invention conceived by the inventor, the interactive mode of the interaction multimedia system is pre-determined by the assembly of interaction codes. The interactive mode could be activated by the setup of a certain time frame automatically. However, there is no such function for a user to initiate the interactive mode once the user to know the detailing information during the multimedia playing procedure. In this case, if the system could be advanced a function for the user to start the pre-determined interaction mode actively, it would be better for the user to go deep into the multimedia material. Particularly, the user controls the action on when and how, much aggressively learning than a passive multimedia input to oneself.

### SUMMARY OF THE INVENTION

It is therefore an object of the present invention to provide an integrated interactive multimedia file which contains selected interaction information. If the integrated interactive multimedia file is played in a dedicated playing device, the interactive functions will be displayed and demonstrated. Especially, a specific interactive effect or performance will be initiated, when a pre-determined function key is pressed by the user in case that the user want to activate the interaction detailing information during the playing.

To achieve the former object, an integrated interactive multimedia playing system, comprising an interactive multimedia file, containing interaction information; a playing control module for playing said interactive multimedia file; a display device, connected to said playing control module, for displaying said interactive multimedia file; a function key module; a detection module for detecting an initiation of said function key module and sending a initiation signal; and an interaction decrypting module, for decrypting said interaction information to said playing control module, upon receiving said initiation signal, wherein said playing control module and said interaction decrypting module coordinate together to conduct interaction functions contained in said interaction information.

In order to achieve the object and function as described in the above, the display device is a LCD monitor.

In order to achieve the object and function as described in the above, the interactive multimedia file is a streaming multimedia file stored in a remote medium server.

In order to achieve the object and function as described in the above, the interactive multimedia file is generated by an input unit for connecting a multimedia generating device; a file format recognition unit, connecting said input unit, for recognizing a multimedia file transmitted from said multimedia generating device; an editing unit for integrating interaction data into said multimedia file; and a format generating unit for producing an interactive multimedia file.

It is yet another object of the present invention to provide an integrated interactive file system which contains different interactive file formats for sharing purpose and capable of playing in an ordinary player.

In order to achieve the forgoing object and function as described in the above, the format generating unit comprises a dedicated format integration unit for transforming said integrated interactive multimedia file into a dedicated interactive multimedia file which is playable on a dedicated player, and an interaction data appending unit for appending said interaction information, which is transformed from said interaction data, to the end of said multimedia file.

In order to achieve the forgoing object and function as described in the above, the multimedia generating device is a digital still camera which is capable of recording motion clips.

The above-mentioned and other features and objects of this invention and the manner of attaining them will become more apparent and the invention itself will be better understood by reference to the following description of a preferred embodiment of the invention taken in conjunction with the accompanying figures wherein:

### BRIEF DESCRIPTION OF THE DRAWINGS

FIG. 1 is a perspective view showing the connection of the present invention and other portable devices;

FIG. 2 is a flow chart showing the multimedia file be recognized and be processed by the interactive multimedia integration system;

FIG. 3 is a detailed block diagram showing the multimedia file be processed to different interactive multimedia file and then be output;

FIG. 4A shows the interactive mark is inserted in-between two multimedia files which are with different formats;

FIG. 4B shows a dedicated integrated interactive multimedia file format by appending interactive scripts at the end;

FIG. 4C shows a commonly utilized file format by attaching interactive codes at the end;

FIG. 5A is a table showing the content of the interactive mark;

FIG. 5B is a table showing the content of the interactive script;

FIG. 5c is a table showing the content of the interactive code, especially to an ordinary multimedia file, as AVI shown, for sharing purpose;

FIG. 6 shows the system modules of the present invention, especially to the involved function key detecting module and the script decoding module; and

FIG. 7 shows the function block diagram of the present invention when the interactive mode is initiated by the user.

### DETAILED DESCRIPTION OF THE PREFERRED EMBODIMENT

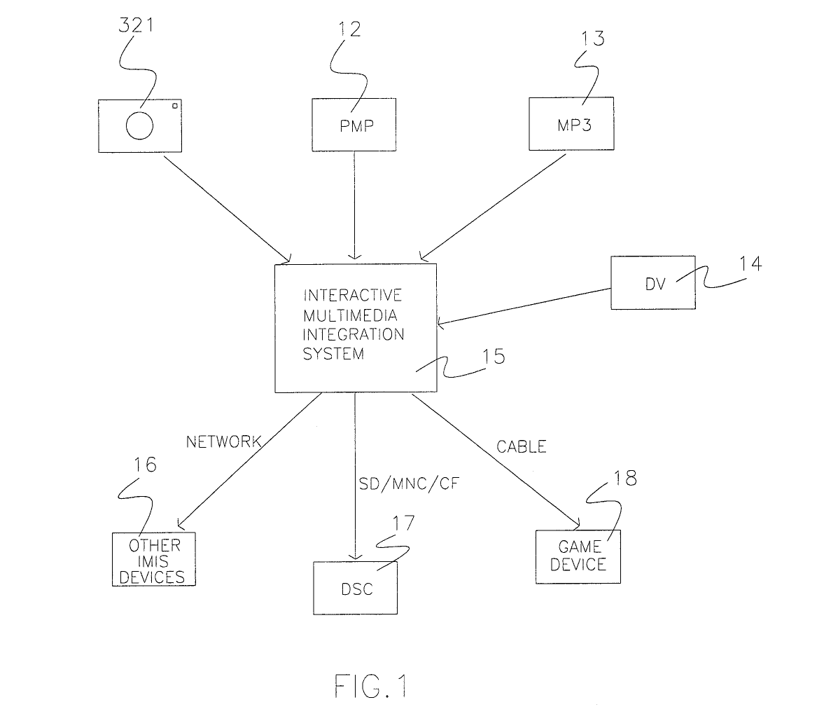

Referring to FIG. 1, files in different formats generated in the digital still camera (DSC) 11, personal media player (PMP) 12, MP3 player 13 and digital video camcorder (DV) 14 are transferred to an interactive multimedia vintegration system (hereinafter as “IMIS”) 15 via several connection methods, such as though cable, USB port, memory cards (CF, SD, MMC or the like) and wireless connection (Blue Tooth, 102.11 a/b/g or the like), Further after appending interactive codes or scripts to the file, the IMIS 15 will output the integrated interactive file to a designated devices, such as another DSC 17, a portable gaming machine 18 or another IMIS for playing purpose. The output connection includes the ways of cable connection, USB port, memory cards and the wireless connection as well. Besides, the IMIS 15 may contain a device recognition interface for assigning a firmware/driver once a recognized device is connected to the IMIS 15. The recognition interface may also recognize an output device if a playing device is connected to the IMIS 15. In this case, the IMIS 15 will transform the output interactive multimedia file into an accepted format in accordance with the recognized playing device. For instances, if the playing device is another IMIS 15, the system will generate and output an IMIS file. If the playing device is an ordinary portable media player, the system will output a commonly utilized file format but appending an interactive scripts. In this case, even if the playing device does not support interactive function, the multimedia file is still able to be played, only the interactive functions being filtered. Further if the playing device is a particular designed playing device, the system will output files consisting of different formats and interactive marks between formats. In view of the above, it is shown that the IMIS 15 device may be implemented a display for playing multimedia file purpose.

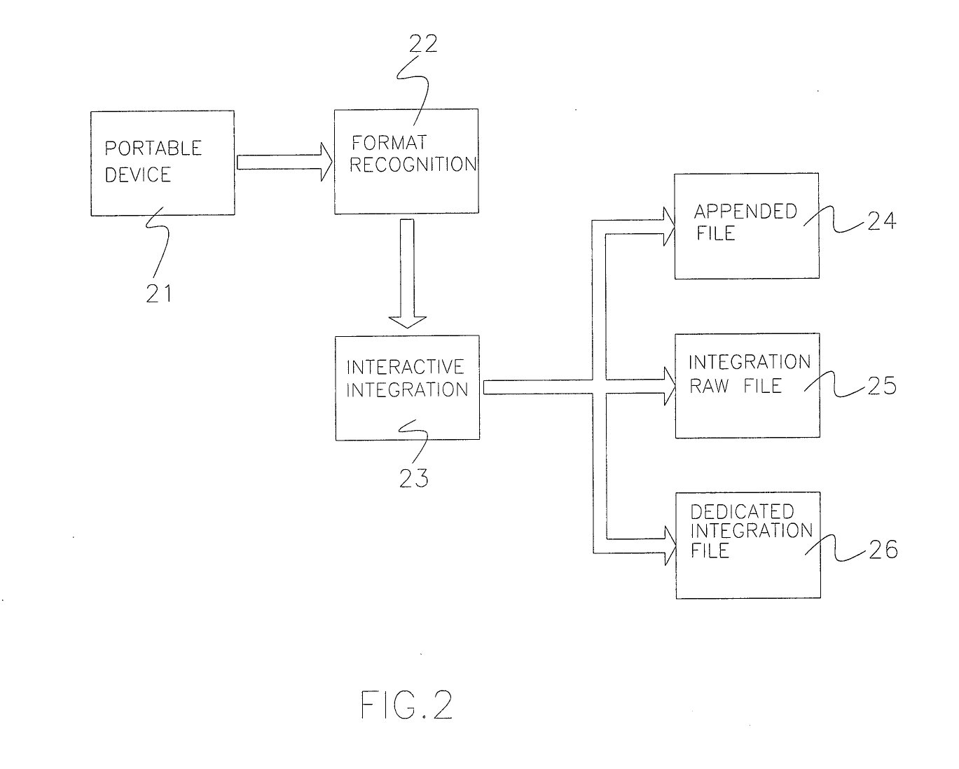

Referring to FIG. 2, it shows the function block diagram of the present invention. At first, the portable device 21, such as DSC or DV, is connected to a format recognition block 22. The format recognition block 22 will recognize the file format and further initiate a proper driver to download the multimedia file which is generated or stored in the portable device 21. There is a mapping table for the format recognition block 22 to sort out the brand and the model name of the connected portable device 21. The multimedia file will be sent to the integration block 23 of IMIS for further interactive data processing. The interactive data process is by appending interaction scripts or inserting interaction marks between different formats. By the request of the user, the integration block 23 of IMIS will generate three kinds of format, such an ordinary multimedia file appending an interaction script shown as the block 24, an IMIS format raw interaction file shown as the block 25 or an dedicated interaction file shown as the block 26. After the integrating and generating process, a playing device can display the multimedia file with interactive instruction information once the interactive multimedia file is transmitted by an output device 36.

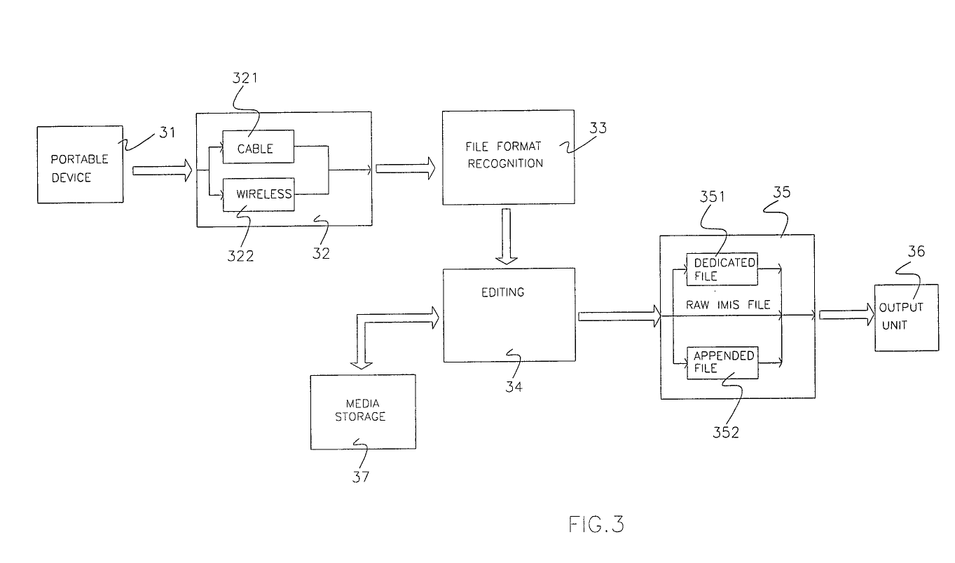

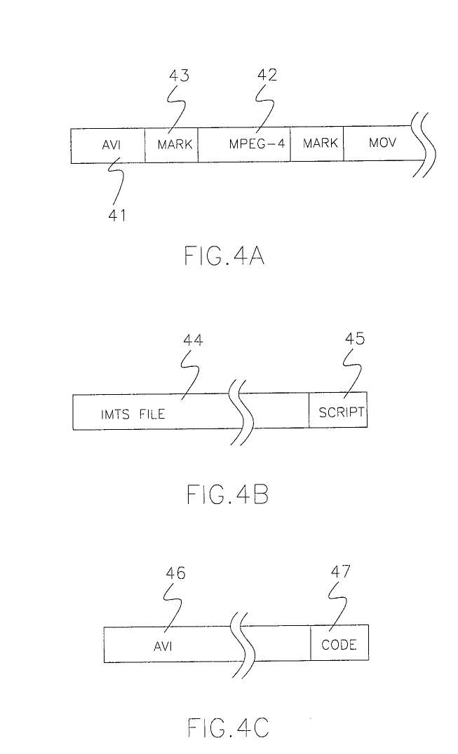

Please refer to FIG. 3, the block diagram shows the detailed processing and integrating method of the present invention. The interactive multimedia integration system includes an input unit 32, a file format recognition unit 33, an editing unit 34, a format generating unit 35 and an output unit 36. The input unit 32 connects a portable device 31 for inputting the multimedia file produced or stored in the portable device into the system. The connection of the input unit 32 and the portable device may either by a cable connection 321 or by a wireless connection 322. The file format recognition unit 33 is utilized for recognizing the file format of the portable device and further setting a proper connection to transmit the multimedia file into the editing unit 34. The editing unit 34 employs a storage unit 37 (such as a hard disk or a ram) for inserting interaction marks or appending interaction scripts. The interaction codes contained in the inserted marks or the appended scripts are fade-in, fade-out, menu, jump-to, remark and so on. Such codes are the basic for interactive functions. However, wide variation of interaction codes may be introduced at a higher complex system. Regarding the functions of the file generating unit 35 includes the direct raw IMIS file output, the dedicated file generating 351 and the ordinary file out with appending interaction code 352. Firstly the raw IMIS file output is outputting the file directly from the editing unit 34 to the output unit, without making any processing onto the integrated IMIS file which is a raw interactive multimedia file. If the user would like to employ an ordinary multimedia player for displaying purpose but wish to keep the interaction codes make to the file previously, the file generating unit 35 may generate the ordinary multimedia file (such as MOV, AVI or MPEG-4) by appending an interactive script segment such as shown in the block 352 and shown in FIG. 4C. If the user would like to employ a dedicated player for playing the integrated interactive multimedia file, the block 351 of dedicated file generating is employed. The multimedia file with interaction information will be produced to the dedicated file and further sent to the out unit 36 for transmitting to a dedicated player which is capable of playing an integrated interactive multimedia file.

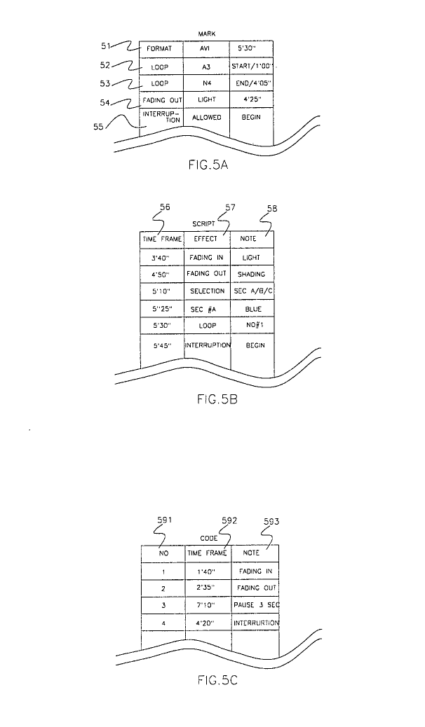

Further referring to FIG. 4A, the raw IMIS file format is shown. The multimedia files with different formats, such as the AVI format file 41 and MPEG-4 format file 42, are integrated altogether. Specifically, between the AVU format file 41 and the MPEG-4 format file 42, there is inserted an interactive mark 43 for containing interaction information. If the player is capable of playing different format and recognizing the interactive mark, the raw IMIS file could be played interactively. The interactive mark, as shown in FIG. 5A, contains interaction information such as the format type 51, assigned loop A3 52, assigned loop N4 53, fading-out instruction 54 and interruption information 55. In the row of format type 51, the format information such as AVI and film length as 4′30″ is shown. In the row of assigned loops of A3 and N4, the starting point and the ending point may be further defined therein. In the row of the fading-out instruction 54, the light fading and the starting point as 4′25″ are demonstrated. In the row of the interruption, the information of “allowed” and the interrupted point at the beginning are demonstrated. In accordance with the interaction information, different arrangements of the marks and the files would produce different interactive effects, such as jumping to a specific loop, recursive jumps, menus, or fading-in effects.

FIG. 4B shows another IMIS file which is transformed from the raw IMIS multimedia file to a dedicated interactive multimedia file. The interactive script 45, which contains interaction information, is located at the back of the file, more likely as a tailor of the dedicated IMIS file. The file format is specifically and substantially changed to another way that is different to AVI, MOV, MPEG-4 and others. The purpose of the dedicated multimedia file is for eliminating duplex information and data contained in input file segments as demonstrated in FIG. 4A. This would shorten the length of the multimedia file and further reduce the size of an integrated interactive multimedia file. Particularly, the dedicated format of the interactive multimedia file 44 may be well integrated on the interaction references. In this case, the scrip 45 may contain interaction information in different ways, such as a list of the time frame 56, the effect 57 and the corresponding note 58 in columns. The column of time frame 56 would state the specific frames, such as the 3′″, 4′50″, 5′10″, 5′25″ and so one. And for corresponding frames, the effects may be the interaction functions of the fading-in, fading-out, selection, section A, loop and so on. Beside the effects described in the foregoing, for each corresponding time frame and the related effect, the column of the note may further define specific effects, such as the “light” fading-in, “shading” fading-out, sections A to C, loop #1, or as a blue background for section A. Moreover, the interactive script may contain more information about the source of the file, length of the film, author name, compatible specification, fading-in function, menu function, fading-out function, jumping and so on. If the interactive multimedia file 44 is not dedicated (or not specifically designed for), the script 45 will be more complex for containing much more interaction information. Such example will be detailed in FIGS. 4C and 5C.

In case of the interactive multimedia to be displayed in an ordinary playing device, such as the DVD player, mobile phone or the DSC, the raw IMIS file and the dedicated IMIS file may be transformed to a commonly utilized file format such by appending interactive code at the end of the ordinary multimedia file, such as the AVI, MOV, MPEG-4 format and so on. Now please refer to FIG. 4C. The ordinary file 46 (or so-called the commonly utilized multimedia file) is attached by the section of interactive code 47 which contains the interaction information and controlling data. The contents of the interactive code 47 are shown in FIG. 5C. The interactive code 47 contains the interaction information, basically divided by at least three major categories of the listing number 591, the time frame 592 and the effect note 593. However, as demonstrated in FIG. 5B and the corresponding description to the interactive script 45, the interactive code 47 may include more interaction information. Therefore, the major categories of the interactive code 47 would exceed three more columns for detailing the wanted interaction performance. As disclosed in this embodiment, the columns of the listing number 591, the time frame 592 and the effect note 593 are for addressing how the interactive effect goes and when the interactive effect initiates. For the instance of the listing numeric numbered as #1, the effect is the fading-in function starting at 1′40″. As the listing numeric numbered as #3, the multimedia file will be paused for 30 seconds at 7′10″ of the time frame. Moreover, the note shown as the listing numeric numbered #1 could contains more detailed information, such as “FADING-IN, BLUE”. In this case, the fading-in function would bring the blue hue at the fading-in orientation screen. However, the most important point is that the ordinary multimedia file 46 is set to AVI, MOV or MPEG-4. In this case, even the playing device doesn't support the interaction function or cannot recognize certain interactive codes, the ordinary multimedia file 46 is still able to be played on the playing device, such as a traditional DVD/CD player or a outdated models of DSC/DV. Even though the interactive code cannot be interpreted properly or even recognized, the fore portion of the integrated interactive multimedia file, such as the multimedia file 46, is still capable of sharing to other players.

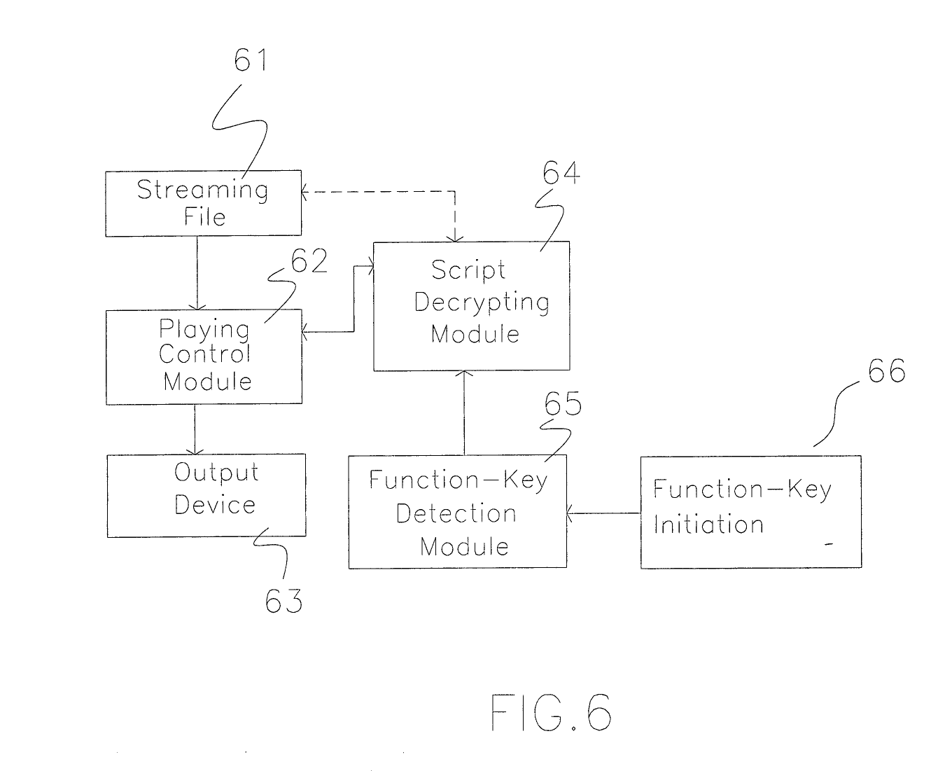

FIG. 6 shows the interruption mechanism of the present system, and particularly the interruption for initiating interaction function is upon the request from the user during the playing procedure. Firstly, the multimedia file could be a streaming multimedia file. The example of the present invention shows the interruption of a streaming multimedia file 61 and demonstrates the interactive initiation after the interruption made by a function key. In FIG. 6, the streaming multimedia file 61 is transmitted to the playing control module 62. The playing control module will therefore play the transmitted screen on a display device 63, such as a LCD monitor, TV or a flat panel TV When a dedicated and pre-determined function key device 66 is pressed, the function key detection module 65 will detect the action made by the user and therefore send an initiation signal to an interaction decrypting module 64 for demonstrating the received interaction information from the streaming multimedia file 61. The interaction decrypting module 64 will further coordinate the playing control module 62 to perform interaction functions contained in the streaming multimedia file on the display device 63. However, the interaction decrypting module 64 could monitor the streaming multimedia file all the time. And after the function key being pressed, the interaction decrypting module 64 will perform the monitored interaction information from the beginning on the display or only perform the interaction information at that interruption point. As stated in the above, the different approaches are dependent upon the design of the interaction information. On the other way, the interaction decrypting module 64 may only monitor the streaming multimedia file 61 after the interruption being initiated. It is specifically an approach at a streaming media system, which is different to the system shown in FIG. 1, wherein the interactive multimedia file is integrated by several multimedia files in different file formats. In this case, only the function key is pressed, the interaction decrypting module will act. As the foregoing description, in either way, the user may actively initiate the interaction functions for education purposes by the help of the function key, during the playing. Moreover, the interaction information may contain the contents of the interactive marks, interactive scripts and the interactive codes shown in FIGS. 5A, 5B and 5C, such as the fading-in with specific color, fading-out, menu, selection, section name, loop name, recursive point, jumping, segmented time frame list, special remark and so on.

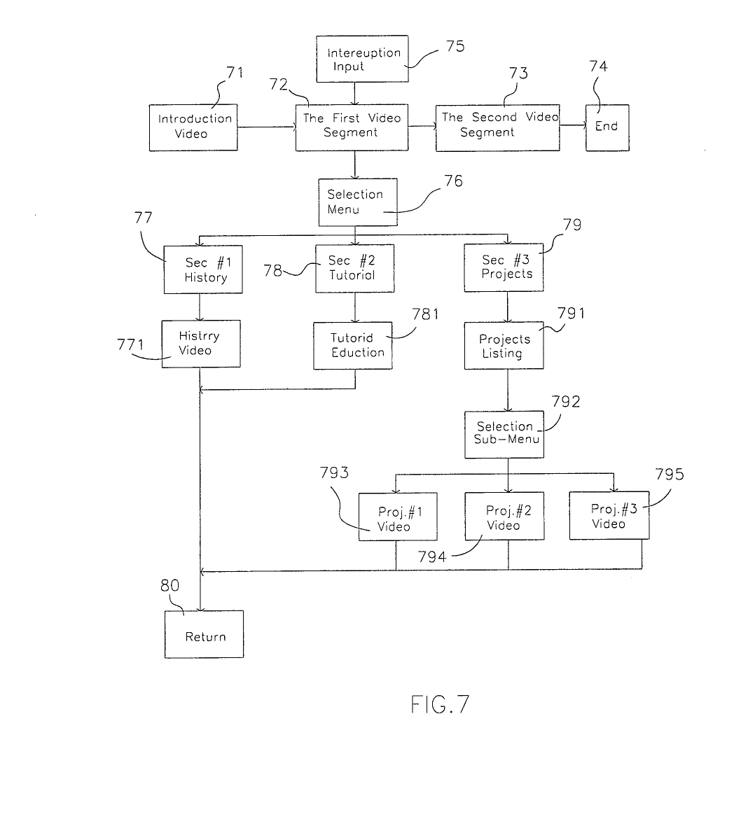

FIG. 7 shows an example of the present invention for conducting a tutorial interactive orientation particularly when an audience is willing to go detailing on a certain interested project. Firstly, the introduction video clips 71 are played. Then the playing control module 62 (as shown in FIG. 6) addresses the system to play contents of the first video segment 72. If the audience is fine with the played contents, the playing control module 62 will therefore bring up the second video segment 73 after the first video segment is finished. If there are more video segments inputted or stored on the system storage medium, the video segments will be played one by one. After all segments being finished, the clip end 74 will be shown on the display device 63. However, if the audience is interested in a subject during the playing, such as a certain content of the first video segment at a specific time frame of the first video segment 72, the audience may click or press on the function key which is a physical key or a click button shown on a touch-screen-panel. The system will be advanced to a selection menu 76 by recognizing an interruption input 75 from the detection module 65. However, the selection menu 76 is introduced just for an example. It may be changed by the variation of designing interaction functions, such as bringing up a jump, a recursive loop and others. The display device 63 will show up the history section 77, tutorial section 78 and project section 79. It is not necessary for the system to show the history, tutorial and project list. It is upon the interaction is designed to perform. Besides, the playing of the first video segment 72 may be continued or paused. And the screen may be fully occupied by the selection menu 76, or be divided to two portions for both playing and the menu. Moreover, the playing and the menu may be overlapped by a set opacity in a different percentage for transparent reviewing purposes. Furthermore, the procedure initiated by the interruption

Please refer to FIG. 7. If the audience chooses the history section 77, the history video 771 is therefore played. After the playing of the history video 771 being finished, the interruption will be forward to the return procedure 80 for going back the first video segment 72 or replaying the specific time frame which is paused previously. If the audience chooses the tutorial section 78, the recorded tutorial video 771 is therefore played. After the finishing of the tutorial video 781, the interruption will be forward to the return procedure 80 for going back the first video segment 72 or replaying the specific time frame which is paused previously. If the audience selects project section 79, the project list 791 will be shown and further advanced to sub-menu 792. The sub-menu 792 will show up selection options of the first project video 793, the second project video 794 and the third project video 795. Each selections of the sub-menu 792 will go further to play the corresponding project videos, such as the first project video 793, the second project video 794 and the third project video 795, for demonstrating the selected project to the audience. After the playing, the system will advance to the return procedure 80, for carrying on the playing of the first video segment 72. However, the return procedure 80 may be further defined as the returning function. In this case, the system will return to the superior function which would be the selection menu 76 or the sub-menu 792. By this way, the audience may choose tutorial video after reviewing the history video, and may review project videos one after the other.

As described in the above, the interactive multimedia file may be integrated from several files or may be stored in a remote storage server. If the remote storage server is utilized, the interactive multimedia file would be transmitted via the streaming protocol over the network. The system may include a network module for detecting remote database. In this case, the history video 771, tutorial video 781 and other directing video may be stored in the remote serve for updating purposes. The videos may be updated at the first time for adding the news. It is very convenient that the interaction function contains news-related information.

Accordingly, there has been disclosed the present invention. While an illustrated embodiment of this invention has been disclosed herein, it is understood that various modifications and adaptations to the disclosed embodiment are possible, and it is intended that this invention be limited only by the scope of the appended claims.

What is claimed is:

1. An integrated interactive multimedia playing system, comprising:
an interactive multimedia file, containing interaction information;
a playing control module for playing said interactive multimedia file;
a display device, connected to said playing control module, for displaying said interactive multimedia file;
a function key module;
a detection module for detecting an initiation of said function key module and sending a initiation signal; and
an interaction decrypting module, for decrypting said interaction information to said playing control module, upon receiving said initiation signal,
wherein said playing control module and said interaction decrypting module coordinate together to conduct interaction functions contained in said interaction information.

2. The integrated interactive multimedia playing system of claim 1, where said display device is a LCD monitor.

3. The integrated interactive multimedia playing system of claim 1, where said interactive multimedia file is a streaming multimedia file stored in a remote medium server.

4. The integrated interactive multimedia playing system, wherein said interactive multimedia file is generated by
an input unit for connecting a multimedia generating device;
a file format recognition unit, connecting said input unit, for recognizing a multimedia file transmitted from said multimedia generating device;
an editing unit for integrating interaction data into said multimedia file; and
a format generating unit for producing an interactive multimedia file.

5. The integrated interactive multimedia playing system of claim 4, where said format generating unit comprises
a dedicated format integration unit for transforming said integrated interactive multimedia file into a dedicated interactive multimedia file which is playable on a dedicated player, and
an interaction data appending unit for appending said interaction information, which is transformed from said interaction data, to the end of said multimedia file.

6. The integrated interactive multimedia playing system of claim 4, where said multimedia generating device is a digital still camera which is capable of recording motion clips.

7. The integrated interactive multimedia playing system of claim 4, where said multimedia generating device is a digital video camcorder.

8. The integrated interactive multimedia playing system of claim 4, where said interaction data is a menu.

9. The integrated interactive multimedia playing system of claim 4, where said interaction data is a fading-in function.

10. The integrated interactive multimedia playing system of claim 4, where said interaction information contains the list of time frame segments and the interactive effect remarks.

11. An integrated interactive multimedia playing system, comprising:
an input unit for connecting a multimedia generating device;
a file format recognition unit, connecting said input unit, for recognizing a multimedia file transmitted from said multimedia generating device;
an editing unit for integrating interaction data into said multimedia file;
a format generating unit for producing an interactive multimedia file, having
a dedicated format integration unit for transforming said integrated interactive multimedia file into a dedicated interactive multimedia file which is playable on a dedicated player, and
an interaction data appending unit for appending said interaction information, which is transformed from said interaction data, to the end of said multimedia file;
an interactive multimedia file, containing interaction information;
a playing control module for playing said interactive multimedia file;
a display device, connected to said playing control module, for displaying said interactive multimedia file;
a function key module;
a detection module for detecting an initiation of said function key module and sending a initiation signal; and
an interaction decrypting module, for decrypting said interaction information to said playing control module, upon receiving said initiation signal,
wherein said playing control module and said interaction decrypting module coordinate together to conduct interaction functions contained in said interaction information.

12. The integrated interactive multimedia playing system of claim 11, where said display device is a LCD monitor.

13. The integrated interactive multimedia playing system of claim 11, where said interactive multimedia file is a streaming multimedia file stored in a remote medium server.

14. The integrated interactive multimedia playing system of claim 11, where said multimedia generating device is a digital still camera which is capable of recording motion clips.

15. The integrated interactive multimedia playing system of claim 11, where said multimedia generating device is a digital video camcorder.

16. The integrated interactive multimedia playing system of claim 11, where said interaction data is a menu.

17. The integrated interactive multimedia playing system of claim 11, where said interaction data is a fading-in function.

18. The integrated interactive multimedia playing system of claim 11, where said interaction information contains the list of time frame segments and the interactive effect remarks.
